(19) United States
(12) Patent Application Publication
(10) Pub. No.: US 2003/0105973 A1
(43) Pub. Date: Jun. 5, 2003

(54) Virus epidemic outbreak command system and method using early warning monitors in a network environment

(75) Inventors: Yung Chang Liang, Cupertino, CA (US); Yi-fen Eva Chen, Pasadena, CA (US); Wei-Ching Chang, Taipei (TW)

Correspondence Address: Ya-Chiao Chang, c/o BAKER & McKENZIE, 29th Floor, 805 Third Avenue, New York, NY, 10022, US

(73) Assignee: Trend Micro incorporated

(21) Appl. No.: 10/264,107

(22) Filed: Oct. 1, 2002

Related U.S. Application Data
(60) Provisional application No. 60/337,533, filed on Dec. 4, 2001.

(51) Int. Cl. G06F 11/30

(52) U.S. Cl. 713/200

(57) ABSTRACT

The invention generally provides a virus epidemic outbreak command system and method using early warning monitors in a network environment with an optimal and expeditious virus scanning functionality embedded therein. The method according to a preferred embodiment of the invention comprises the steps of detecting data traffic flow in all the device nodes in the network system, determining a neighborhood of the plurality of device nodes in the network system having unpredicted traffic flow, designating those of the device nodes in the network system having unpredicted traffic flow as abnormal device nodes and those of the device nodes having predicted traffic flow as normal device nodes, deploying at least one network neighborhood monitor for detecting data traffic flow in the abnormal device nodes, partially isolating a segment in the network system including the abnormal device nodes, scanning those of the data files in the isolated segment, transferring an antivirus cure into the isolated segment for pinpointing at least one infected file among the data files in the network system that is infected by at least one computer virus, preventing all traffic flow into the isolated segment except the transferred antivirus cure, reducing the size of the isolated segment by rejecting all normal device nodes in the isolated segment, and removing the at least one infected file from the isolated segment using the antivirus cure.

### RELATED APPLICATIONS

The claimed invention in the present patent application generally relates to, and claims priority of, U.S. Provisional Patent Application Serial No. 60/337,533 filed on Dec. 4, 2001, which is incorporated by reference herein.

### BACKGROUND OF THE INVENTION

1. Field of the Invention

The claimed invention in the present patent application generally relates to antivirus control in a network system and, more particularly, an antivirus method and device against computer virus outbreak in a network environment with a plurality of device nodes under malicious code attack, with an optimal and expeditious virus scanning functionality embedded therein.

2. Description of the Related Art

When a network encounters an undesirable code attack, network manager(s) and information technology (IT) specialists need to investigate the situation as soon as the attack is discovered. IT specialists then determine the proper tools that would most effectively block and, hopefully, remove the undesirable intruding code altogether and restore the network system to normal as soon as possible. The process of pinpointing the intruding code and finding the proper solution is often tedious, complex and time consuming.

The Internet is an ideal mass medium for the spread of computer viruses since virtually, every computer needs to be connected to another computer or network either directly or indirectly. The Internet, with all its benefits and fascinations, is nonetheless an effective and efficient medium for an intentional spread of malicious code attack. It has been estimated that some fast-paced viruses can spread throughout the entire Internet within a matter of a couple of hours if not effectively stopped.

For any network environment, be it the Internet, a wide area network (WAN), a corporate local area network (LAN) or even wireless communications networks for mobile phones and personal digital assistant (PDA) devices, the more data transmitted and the more services offered, the more likely viruses are able to infect those networks.

In day-to-day efforts against computer viruses and other terminal device viruses, an end user is constantly looking for solutions against such viruses. Even in the case of corporate networks that are closely guarded by an antivirus firewall and all sorts of virus protection software, some viruses are still able to penetrate then and do great herein. This is because conventional antivirus technology generally relies on already identified viruses. In other words, conventional antivirus schemes are usually effective against known computer viruses, but are unable to block unknown viruses. A newly captured virus has to be analyzed by, e.g., an antivirus service provider. Therefore, terminal devices such as computers connected to a LAN or WAN is generally unable to have antivirus protection against unknown viruses with conventional antivirus software.

When the terminal device or computer connected to a network is subject to attack by an unknown virus penetrating into the network, it is the responsibility of network managers to guard against such attacks and the restore the network to normal operating status as quickly as possible. The level of preparedness in a network is dependent upon knowing the probability of a virus successfully penetrate the corporate network, e.g., LAN. When a computer virus does penetrate into a corporate LAN, the spreading of the virus infection in the network will be only as fast and as end effective as users on the LAN are able to utilize the network. Some of the latest viruses are so fast and ferocious that LAN managers must immediately implement rapid and effective counter-measures in order to reduce the damage likely to result.

One conventional measure a LAN manager can undertake is to physically unplug network cables when there is an outbreak of a ferocious virus that has already penetrated the LAN. However, such drastic measures are likely to undesirably affect the uninfected sectors of the corporate LAN as well as cause inconvenience for end users. On the other hand, any hesitation, including the time spent on retrieving antivirus tools, can lead to greater damage to the corporate LAN. In the time frame for an antivirus service provider to analyze and implement a cure, the entire corporate LAN might be thoroughly infected.

Another conventional antivirus measure is the deployment of antivirus software programs in a network. These antivirus programs are typically implemented as utility programs separate from the executable programs, which scan files resident in one or more computers in the network and accordingly determine whether the files are infected with a recognizable computer virus. Once a file is determined to be an infected file, the antivirus programs can cure the infected file by removing the virus from the file and the associated computer in the network.

There is thus a general need in the art for effective and optimal antivirus control against computer viruses in a network system overcoming at least the aforementioned shortcomings in the art. In particular, there is a need in the art for antivirus method and device against computer virus outbreak in a network environment with a plurality of device nodes under malicious code attack, with an optimal and expeditious virus scanning functionality embedded therein. Moreover, there is a particular need in the art for a virus epidemic outbreak command system and method using early warning monitors in a network environment with an optimal and expeditious virus scanning functionality embedded therein.

### SUMMARY OF THE INVENTION

The invention advantageously provides effective and optimal antivirus control against computer viruses in a network system overcoming at least the aforementioned shortcomings in the art, and more particularly, an antivirus method and device against computer virus outbreak in a network environment with a plurality of device nodes under malicious code attack with an optimal and expeditious virus scanning functionality embedded therein. A preferred embodiment of the invention generally provides a virus epidemic outbreak command system and method using early warning monitors in a network environment with an optimal and expeditious virus scanning functionality embedded therein.

A preferred embodiment of the invention advantageously provides a virus early warning method in a network system having a plurality of data files and device nodes. The method according to this particular embodiment of the invention comprises the steps of detecting data traffic flow in all the device nodes in the network system, determining a neighborhood of the plurality of device nodes in the network system having unpredicted traffic flow, designating those of the device nodes in the network system having unpredicted traffic flow as abnormal device nodes and those of the device nodes having predicted traffic flow as normal device nodes, deploying at least one network neighborhood monitor for detecting data traffic flow in the abnormal device nodes, partially isolating a segment in the network system including the abnormal device nodes, scanning those of the data files in the isolated segment, transferring an antivirus cure into the isolated segment for pinpointing at least one infected file among the data files in the network system that is infected by at least one computer virus, preventing all traffic flow into the isolated segment except the transferred antivirus cure, reducing the size of the isolated segment by rejecting all normal device nodes in the isolated segment, and removing the at least one infected file from the isolated segment using the antivirus cure.

A network system according to another preferred embodiment of the invention comprises a plurality of data files, a management server connected to a plurality of device nodes wherein those of the device nodes having unpredicted traffic flow are designated as abnormal device nodes and those of the device nodes having predicted traffic flow are designated as normal device nodes, a management information database (MIB) connected to the management server, at least one network neighborhood monitor deployed in the network system for detecting data traffic flow in the abnormal device nodes wherein a segment in the network system including the abnormal device nodes is partially isolated, and an antivirus cure transferred into the isolated segment for pinpointing at least one infected file among the data files in the network system that is infected by at least one computer virus wherein all traffic flow into the isolated segment are prevented except the transferred antivirus cure, wherein the at least one infected file is removed from the isolated segment using the antivirus cure.

A network system according to yet another preferred embodiment of the invention comprises a plurality of data files, a management server connected to a plurality of device nodes, a scanner for detecting data traffic flow in the device nodes, the scanner storing a plurality of virus patterns, wherein those of the device nodes having unpredicted traffic flow are designated as abnormal device nodes and those of the device nodes having predicted traffic flow are designated as normal device nodes, at least one network neighborhood monitor deployed in the network system for detecting data traffic flow in the abnormal device nodes wherein a segment in the network system including the abnormal device nodes is partially isolated, an antivirus cure transferred into the isolated segment for pinpointing at least one infected file among the data files in the network system that is infected by at least one computer virus, and a network switch for switching data traffic flow in the abnormal device nodes wherein the at least one infected file is removed from the isolated segment using the antivirus cure.

### BRIEF DESCRIPTION OF THE DRAWINGS

The above and other features and advantages according to the invention are described herein in the following Detailed Description in conjunction with the accompanying drawings (not necessarily drawn to scale) in which:

FIG. 1 is a schematic diagram generally illustrating an exemplary network structure of the framework for computer virus epidemic damage control in a network environment according to a preferred embodiment of the invention;

FIG. 2 is a flow diagram illustrating an exemplary process of the early warning virus detection method for finding a computer virus according to one preferred embodiment of the invention;

FIG. 3 is a flow diagram illustrating an exemplary grouping and switching process for finding a computer virus according to another preferred embodiment of the invention; and

FIG. 4 is a schematic view illustrating an exemplary antivirus framework for a network using virus patterns and signatures according to another embodiment of the invention.

### DETAILED DESCRIPTION OF PREFERRED EMBODIMENTS

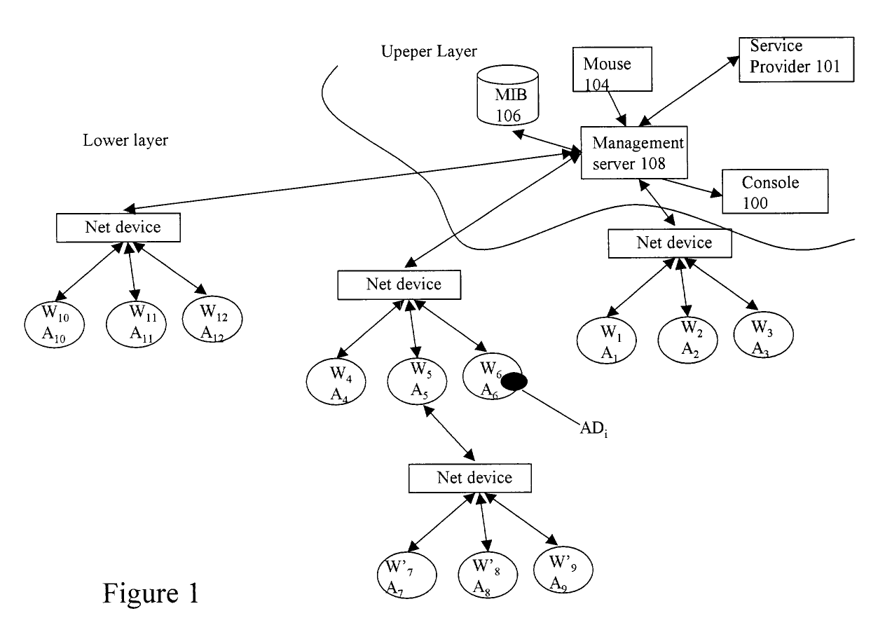

FIG. 1 is a schematic diagram illustrating the general structure of a framework for computer virus epidemic damage control in a network environment according to a preferred embodiment of the invention. The according to this particular embodiment system is a distributed computing environment comprising a plurality of devices. The system can be divided into an upper layer structure and a lower layer structure. The upper layer structure contains the devices in the upper stream of a management server. Conversely, the lower layer structure contains the devices for the downstream of the management server. The management server 108 according to this embodiment of the invention is a programmed digital computer having, user interface devices such as a console 100, keyboard 102 and mouse 104. In the described embodiment, each management server 108 is a network connectable computer or a server device, such as a Sun SparcStation™ workstation running the Solaris™ operating system, a version of the UNIX/RTM operating system, or an IBM-compatible computer running the Windows NT™ operating system. However, use of the systems and processes according to the invention are not limited to a particular computer configuration.

The management server 108 further includes a management information database (MIB) 106, such as a relational database, file system or other organized data storage system, which stores management information in the MIB. Moreover, the management server 108 can be connected with a service provider 101, typically a far end device for providing external services to the management server 108 including services to be performed in the system originally not in the management server 108.

In the lower layer structure, a plurality of individual nodes, called device nodes Wi (where it is an integer), are functionally distributed. In accordance with the invention, each device node Wi corresponds to a managed network device such as a processor, a notebook computer, a desktop computer, or a workstation or other network apparatus, even a handset, and a personal digital assistant (PDA). The state of each managed network device is monitored and controlled by an agent program running in the respective device node. For example, agent programs Ai run in device node Wi. Each agent may also have a local management information database ADi (as exemplarily shown in FIG. 1) that stores status information and parameters for the managed device. In the present invention, the agents can be preinstalled in each device node, or are generated by the management server 108. In operation, a management application program running in the management server 108 cooperates with the agents in managing the network respectively. The management server 108 can download information from the agents (Ai) or from their associated databases ADi. The management server 108 can also set parameters in the network devices by accordingly instructing the agent programs to set parameters and values therein or within their associated drivers.

Generally, a network is divided into different hierarchies such as geographical classification, management classification and detailed network information, which are accordingly displayed in the form of a map having a plurality of hierarchical levels. Such is performed so that the configuration of a large-scale complicated network can be readily identified. The device nodes (Ai) are formed herein as a first layer of the network, whereas the network according to other embodiments of the invention can be a multiple layer network including a first layer, second layer, third layers, etc. As illustrated in FIG. 1, a second layer sub-network is shown, which includes device nodes W′i. The device nodes W′i have generally the same structures as the device nodes Wi, such as their respective agents and agent MIBs.

The upper and lower layer structures in the network system according to this embodiment of the invention are connected as a network through a plurality of network devices such as switches, routers, gateways, etc. The network according to this embodiment includes, bit is not limited to, an Ethernet network, Internet, modified bus network, or the combinations of such networks. A network utilizing embodiments of the invention can be divided into smaller groups based on network segmentation or other suitable schemes and topologies.

A preferred embodiment of the invention advantageously provides a virus early warning method in a network system having a plurality of data files and device nodes. The method according to this particular embodiment of the invention comprises the steps of detecting data traffic flow in all the device nodes in the network system, determining a neighborhood of the plurality of device nodes in the network system having unpredicted traffic flow, designating those of the device nodes in the network system having unpredicted traffic flow as abnormal device nodes and those of the device nodes having predicted traffic flow as normal device nodes, deploying at least one network neighborhood monitor for detecting data traffic flow in the abnormal device nodes, partially isolating a segment in the network system including the abnormal device nodes, scanning those of the data files in the isolated segment, transferring an antivirus cure into the isolated segment for pinpointing at least one infected file among the data files in the network system that is infected by at least one computer virus, preventing all traffic flow into the isolated segment except the transferred antivirus cure, reducing the size of the isolated segment by rejecting all normal device nodes in the isolated segment, and removing the at least one infected file from the isolated segment using the antivirus cure.

A further embodiment of the method according to the invention further comprises a step of quarantining the at least one infected data file. The method according to the invention can further comprise the step of detecting the volume of the data traffic flow in a unit time interval. The data traffic flow can be designated as abnormal if the volume thereof is larger than the volume of the predicted traffic flow with a predetermined value for a predetermined time period. The method according to the invention can further comprise the step of analyzing the data traffic flow in the plurality of device nodes by analyzing the plurality of data files according to predetermined data formats. An additional embodiment of the method according to the invention further comprises the steps of analyzing the data format of the data traffic flow in the plurality of device nodes and designating the traffic flow as abnormal if the data format does not conform with predetermined data formats. The method according to the invention can further comprise the step of mapping predetermined patterns to the data traffic flow in the plurality of device nodes. The method according to the invention can also comprise the step of de-isolating the isolated segment after the at least one infected file is removed from the isolated segment. Yet an additional embodiment of the method according to the invention further comprises the step of writing virus information of the at least one computer virus into a computer virus database. The virus information can comprise date, file name, original location, creation date, last modified date, and file attributes of the at least one computer virus. The method according to the invention can further comprise the step of displaying the virus information in the network system.

A network system according to another preferred embodiment of the invention comprises a plurality of data files, a management server connected to a plurality of device nodes wherein those of the device nodes having unpredicted traffic flow are designated as abnormal device nodes and those of the device nodes having predicted traffic flow are designated as normal device nodes, a management information database (MIB) connected to the management server, at least one network neighborhood monitor deployed in the network system for detecting data traffic flow in the abnormal device nodes wherein a segment in the network system including the abnormal device nodes is partially isolated, and an antivirus cure transferred into the isolated segment for pinpointing at least one infected file among the data files in the network system that is infected by at least one computer virus wherein all traffic flow into the isolated segment are prevented except the transferred antivirus cure, wherein the at least one infected file is removed from the isolated segment using the antivirus cure.

A further embodiment of the network system according to the invention further comprises a computer virus database storing virus information of the at least one computer virus. The virus information can comprise date, file name, original location, creation date, last modified date, and file attributes of the at least one computer virus. The network system according to the invention can further comprise a display for displaying the virus information. An additional embodiment of the network system according to the invention further comprises a scanner for detecting data traffic flow in the plurality of device nodes where the scanner stores a plurality of virus patterns. The network system according to the invention can further comprise a network switch for switching data traffic flow in the abnormal device nodes in the network system. Yet an additional embodiment of the network system according to the invention further comprises a quarantine module quarantining the at least one infected data file. The data traffic flow can be designated as abnormal if the volume thereof is larger than the volume of the predicted traffic flow with a predetermined value for a predetermined time period. The network system according to the invention can also comprise mapping means for mapping predetermined patterns to the data traffic flow in the plurality of device nodes. Moreover, the isolated segment can be de-isolated after the at least one infected file is removed from the isolated segment in the network system.

A network system according to yet another preferred embodiment of the invention comprises a plurality of data files, a management server connected to a plurality of device nodes, a scanner for detecting data traffic flow in the device nodes, the scanner storing a plurality of virus patterns, wherein those of the device nodes having unpredicted traffic flow are designated as abnormal device nodes and those of the device nodes having predicted traffic flow are designated as normal device nodes, at least one network neighborhood monitor deployed in the network system for detecting data traffic flow in the abnormal device nodes wherein a segment in the network system including the abnormal device nodes is partially isolated, an antivirus cure transferred into the isolated segment for pinpointing at least one infected file among the data files in the network system that is infected by at least one computer virus, and a network switch for switching data traffic flow in the abnormal device nodes wherein the at least one infected file is removed from the isolated segment using the antivirus cure. All traffic flow into the isolated segment in the network system are prevented except the antivirus cure being transferred into the isolated segment.

The network system can comprise a local area network (LAN), mobile network, wired and wireless communications network. A further embodiment of the network system according to the invention further comprises a computer virus database for storing virus information of the at least one computer virus. The virus information can comprise date, file name, original location, creation date, last modified date, and file attributes of the at least one computer virus. The network system according to the invention can further comprise a display for displaying the virus information. An additional embodiment of the network system according to the invention further comprises a quarantine module quarantining the at least one infected data file. The data traffic flow can be designated as abnormal if the volume thereof is larger than the volume of the predicted traffic flow with a predetermined value for a predetermined time period. The network system according to the invention can also comprise mapping means for mapping predetermined patterns to the data traffic flow in the plurality of device nodes. Moreover, the isolated segment can be de-isolated after the at least one infected file is removed from the isolated segment in the network system.

A particular embodiment of the present invention constructed in accordance with the above can be considered to be passively providing its intended functionality. In another embodiment according to the invention, an active approach is utilized by employing various predetermined monitoring schemes before, during, and after the epidemic. These active measures, which contribute to the effort of reducing damage level while an entire network is under computer virus attack, and before and after the epidemic, where a scanning system is deployed in the network environment. A scanning system based on, for example, sniffing technology and launched according the invention before, during and after a computer virus epidemic advantageously provides the following functions described in further detail herein and below, including (1) early warning of a virus epidemic outbreak in the network system, (2) network neighborhood monitoring, (3) detailed and accurate trace back of the virus outbreak, (4) observation period cyber patroller, (5) identification of other network neighborhood monitors in the network environment, (6) grouping and switching, (7) virus pattern matching by known virus signatures, (8) virus pattern matching by known virus rules; and (9) a computer virus database.

The virus scanning system according to a preferred embodiment of the invention provides early warning of a network epidemic outbreak. A scanning module is deployed for monitoring abnormal usage of network segments and trigger and outbreak alert to the management server 108. Predetermined traffic analysis schemes can be employed to make this monitoring more accurate, such as an analysis scheme monitoring a predetermined number of device nodes that generate mass traffic. To ensure adequate coverage, that traffic should have large portions in common. Moreover, virus pattern recognition is utilized. Known virus patterns are used to trace the abnormal network usage so as to determine whether virus exists in the application software. Furthermore, a heuristic analysis is utilized to find abnormal sections in application software based on the predetermined knowledge of data formats. Data are stored or packaged in accordance with predetermined formats, which are matched and utilized to track computer viruses in the network system. In addition, the scanning module according to this embodiment of the invention also keeps a record of when and which device nodes start generating traffic. This is helpful for tracing back to the source of a virus outbreak.

The early warning virus scanning system according to the invention further provides the capability of neighborhood monitoring in the network environment. An early warning capability utilizes network neighborhood monitors. This function according to this particular embodiment of the invention is to cover especially non-Wintel (Windows™-Intel™) platforms. This function advantageously prevents an outside intruder or visitor from initiating a virus outbreak when plugging a mobile computer into a network, e.g., a corporate LAN. For best network management practices, a dedicated network segment configured specifically for visitors will generally have the neighborhood monitoring enabled.

For device nodes of a non-Wintel platform, some will have no proper agents acceptable to the management server 108. If the network system detects one device node having abnormal traffic, the management server 108 then assigns at least one device node near the non-Wintel device nodes for monitoring virus outbreak. There are pluralities of manners for determining whether there is a virus outbreak e.g., based on statistics of abnormal traffic or activities, virus patterns or analyses of the behavior of the outgoing sequence with normal behavior.

For neighborhood monitoring in a network environment, network neighborhood monitors are utilized in the virus early warning method according to the invention. This neighborhood monitoring function according to an embodiment of the invention is to cover especially non-Wintel (Windows-Intel) platforms. This function also helps to prevent a visitor from initiating an outbreak when plugging a mobile computer into the network system, e.g., a corporate LAN. For best network management practices, a dedicated network segment specifically configured for visitors can have the neighborhood monitoring function enabled in the network environment.

For device nodes of non-Wintel network platforms, many of the device nodes will have no proper agents acceptable to the management server 108. If the network system detects one or more device nodes having abnormal data traffic, the management server 108 then assigns at least one device node nearby the non-Wintel device nodes for monitoring computer virus outbreak. In determining whether there is a computer virus outbreak in the network system, statistics of abnormal traffics or activities, virus patterns, or analyses the behavior of the data traffic flow in comparison with normally occurring behavior can be considered.

The virus scanning system according to the invention can further include an outbreak trace back function for finding unprotected spots in a network system. A particular functionality for monitoring the activities of network traffic (combined with the early warning functionality in detecting computer virus outbreaks) is advantageously provided in accordance with the invention. Once the outbreak early warning functionality has been triggered, the outbreak track-back module analyzes the data collected starting from a predetermined time prior to the issue of the virus warnings and pinpoints the first introduction of the virus attack into the network environment. The data can also be passed along to an outbreak container or quarantine, which is a module that draws a network firewall line enabling an end user or the network system to secure the outbreak area.

In addition, the virus scanning system according to the invention provides a cyber patroller in an observation period in the network environment. When a computer virus alert is raised, or after the successful clearing of an alert, the behavior of the network needs to be continuously monitored for at least some appropriate period, namely, an observation period. In this observation period, some of the plurality of device nodes can be selected to be the cyber patrollers for specifically monitoring the data traffic in the network system for virus patterns.

The invention can further include an additional functionality for identifying monitors in the network environment other than the neighborhood network monitors deployed therein according to the invention. Under normal circumstances, there should not be any network monitors unknown to the network system or network administrators. The invention advantageously provides a function that provides an overall and comprehensive view of network neighborhood monitors deployed in the network system, and conversely, any network monitors other than those network neighborhood monitors deployed therein.

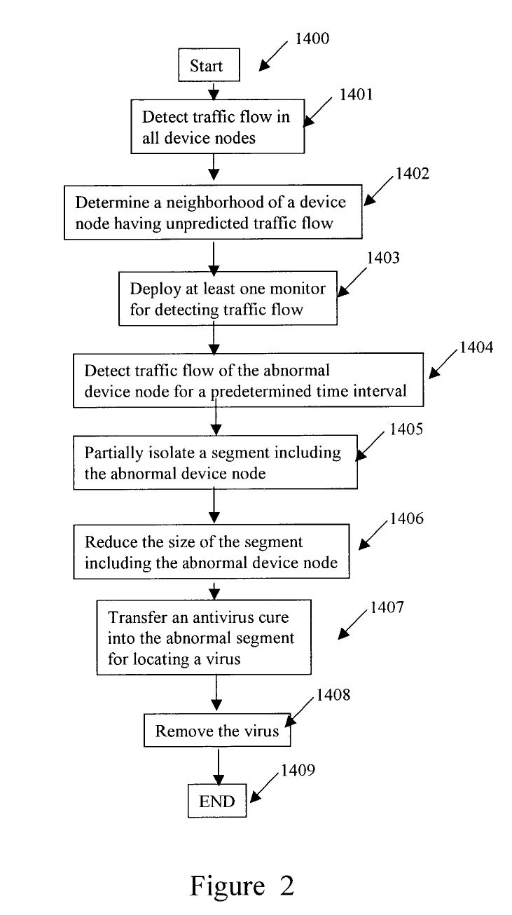

An exemplary process of the method for early virus detection will be described hereinafter with reference to FIG. 2, beginning with step 1400. In step 1401, traffic flow in all device nodes is monitored for finding abnormal traffic flow. In step 1403, a neighborhood of a device node having unpredicted traffic flow is determined. The device node having unpredicted traffic flow is defined as an abnormal device node, whereas a device node having predicted traffic flow is defined as a normal device node. In step 1404, the management server 108 finds at least one network neighborhood monitor for monitoring and detecting the traffic flow of the abnormal device node. In step 1405, the traffic flow of the abnormal device node is determined for a predetermined time interval by the network neighborhood monitor. In step 1406, a segment in the network system including the abnormal device node is partially isolated other than instructions and results assigned by the management server 108. The segment having the abnormal device node is called the abnormal segment. In step 1407, the size of the segment including the abnormal device node is reduced by rejecting the normal device node. Next, in step 1408, the management server 108 transfers an antivirus cure into the abnormal segment for pinpointing a computer virus. In step 1409, the management server 108 instructs the antivirus cure to remove the virus, where the process ends at step 1410.

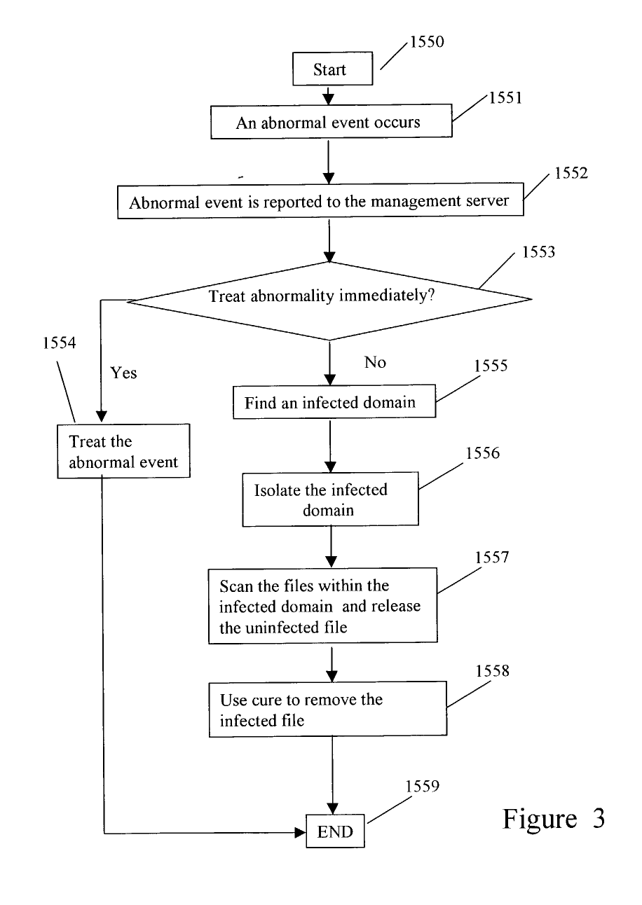

An exemplary grouping and switching process according to the invention is illustrated with reference to FIG. 3, where the process is started in step 1550. When an abnormal event occurs (1551), the abnormal event is reported to the management server 108 (1552). The system determines whether the abnormal event can be treated immediately (1553). The abnormal event can be treated immediately if a computer virus database in the network system includes an antivirus cure corresponding to that abnormal event. If the management server 108 can treat the abnormal event immediately, then the control flow of the exemplary process according to the invention is directed to the next step to treat the abnormal event (1554). If the management server 108 cannot treat the abnormal event immediately, or if the management server 108 cannot find a proper cure for resolving the abnormal event, the management server 108 then quarantines an infected domain in the network system that encloses an infected region containing some of the plurality of device nodes infected by computer viruses (1555). The management server 108 then stops all data traffic into the infected region by switching all the data traffic out of the infected region (1556).

Then manager server 108 can further scan the data files within the infected domain so as to release the uninfected files out of the infected domain. The exemplary process according to the invention is continuously performed so as to reduce the area of the infected domain until all the data files in the infected domain are scanned (1557). After completing the scanning process, the uninfected data files are released from the domain, while the infected data files are locked from inputting and outputting. In the meantime, only antivirus cures for resolving the infection are allowed to enter into or out of the infected domain. The virus patterns infecting the data files are transferred to and recorded in the management server 108, while antivirus cures remove the computer virus (1558). The process ends at step 1559.

In another embodiment of the grouping and switching process according to the invention, after all of the infected domain has been scanned, only the infected files remain in the infected domain. The infected data files are moved into a computer virus database and the routing paths of the infected files are accordingly recorded. The infected domain is then ungrouped. Once the infected files are moved into the virus database, the corresponding computer virus(es) can no longer be spread inadvertently to other programs or otherwise infect the network system. In another embodiment according to the invention, the infected files in remain in the original directories, but the routing paths of the infected files are recorded in the virus database as a reference for managing and monitoring the infected files.

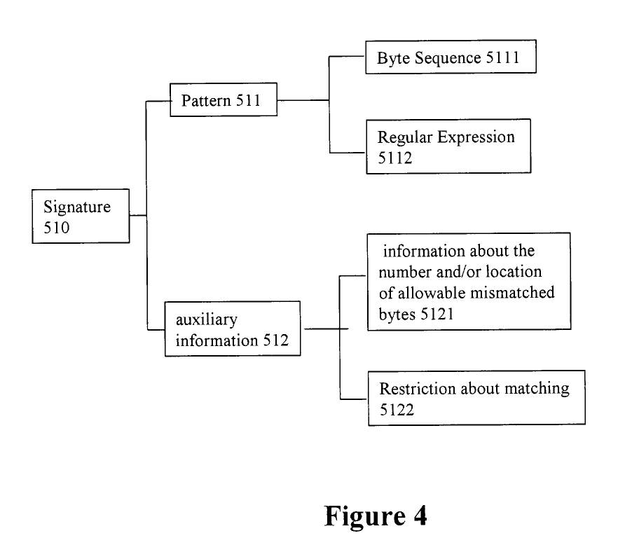

FIG. 4 is a schematic view illustrating an exemplary antivirus framework for a network using virus patterns and signatures according to another embodiment of the invention. A scanner searches potential hosts or device nodes for a set of one or more specific virus patterns of code called virus signatures 510 that are indicative of particular known viruses or virus families or those likely to be included in new viruses. A virus signature typically consists of a pattern 511 to be matched with the data traffic in the network system, along with implicit or explicit auxiliary information 512 about the nature of the match, and possible transformations to be performed upon the input data prior to seeking a match to the pattern. The virus patterns can be a byte sequence 5111 to which an exact or inexact match is to be sought in the potential hosts or device nodes. In general, the virus patterns can be a regular expression 5112. The auxiliary information may also contain information about the number or location of allowable mismatched bytes 5121, where the network may also restrict the match (5122). For example, the match may be restricted to input data representing computer programs in the .EXE format. A further restriction may specify that matches be declared only if they occur in a region within one kilobyte on either side of the data entry point. The auxiliary information may also specify particular data transformations.

Typically, a scanner operates by first loading virus signature data for one or more computer viruses into memory, and then examining a set of potential hosts or device nodes for matches to one or more signatures. If any signature is found, further action can be taken to warn the network system or an end user of the likely presence of a computer virus, and to remove the virus. To identify languages or subject areas, a text can be scanned for sets of keywords, and the occurrence frequencies of those keywords or approximate matches thereto and particular data traits. There is generally mapping from the located occurrences of the virus patterns to a (possibly empty) set of inferred data traits. The mapping may or may not take into account the location of the occurrences within the data string. The mapping can have a one-to-one, one-to-many, or many-to-one mapping format. For example, in computer virus applications, the mapping is generally one-to-one. For virus signatures present in a plurality of computer viruses, several signatures are used to identify a single virus.

The invention further provides virus pattern matching by known virus rules. Other than using known virus signatures to detect computer viruses, other viruses may have no signatures stored in the MIB 106. The virus rules are stored in MIB 106, which are used to detect the abnormal event, if any. If the abnormal event matches some of the virus rules, then a virus potentially exists and the process steps are accordingly adapted as those described in the exemplary grouping and switching process aforementioned above.

The invention can further comprise a computer virus database. An exemplary virus database may comprise a database, controlled access directory, or other data structure holding a plurality of data files and information fields related thereto. The virus database can be implemented in the MIB 106, readily accessible by the management server 108. Control of the virus database may be provided by an antivirus process, which may be a stand-alone application program, part of a system management program, or part of an operating system. In one embodiment according to the invention, the antivirus process may be used to continuously monitor the network system for computer viruses through a memory-resident program providing real-time antivirus protection. The exemplary antivirus process may be used to scan one or more files in a file structure. Prior to scanning for computer viruses, the exemplary antivirus process may prompt the network system or an end user to select an option to deal with the detected computer viruses. In another embodiment according to the invention, the options can further comprise the functionalities of cleaning, deleting, renaming or moving data files to the virus database. After an option is selected, the exemplary antivirus process scans one or more selected files. In alternate embodiments, an end user may be individually prompted to select an option for each data file in which a virus is detected. If the virus database option is selected, the exemplary antivirus process moves an infected file to the virus database for safekeeping and storing information related to the infected file. An end user may view information regarding data files placed in the virus database at any time using a graphical user interface (or GUI). The exemplary antivirus process may present an end user with a number of options for managing the infected files. In an additional embodiment according to the invention, an end user may instruct the network system to clean the infected files by removing computer virus(es) therein, restoring the infected files to the original storage location without cleaning, deleting the infected files, saving to a different storage location, renaming the infected files, or sending the infected files to another location.

In addition, an end user may view the contents of the virus database at any time. The network system advantageously provides an end user with an option of displaying the contents of the virus database. When the view virus database option is selected, the contents of the virus database are displayed. The virus database can display information regarding virus infected files, such as the date the file was added to the virus database, the file name, viruses that the file contains, and the original location of the file in the network system before it was moved to the virus database, etc.

In a further embodiment according to the invention, once the virus infected file is safely moved into the virus database, the computer virus therein can no longer be spread inadvertently to other programs or otherwise infect the network system. In one embodiment, an end user may take additional action by selecting a data file and choosing from a plurality of additional actions in a pop-up menu. An undo operation can restore a data file to its original location upon removal of computer virus(es) from the file. A clean operation removes computer virus(es) from the data file and then restores the file to its original location. A delete operation permanently removes the infected file from the virus database.

In addition, as an infected file is detected in the network system, virus information is accordingly written to a newly created file. Virus database header information may comprise the current date, file name, original location, original file creation date and the last modified date, file attributes, and the name of the virus infecting the file. The infected file may be scrambled or encrypted and copied to the virus database in a location corresponding to the newly created file following the virus database header information. In another embodiment according to the invention, the virus database header information may be stored in the virus database separate from the scrambled infected files. The scrambling or encrypted operation may be performed on a byte-by-byte basis during the copying operation. The virus-infected file may then be deleted.

Embodiments of the invention may be implemented in hardware or software, or a combination of thereof. Embodiments of the invention may also be implemented as computer programs executing in programmable systems. Program code may be applied to input data to perform the functions described herein and accordingly generate output information. The output information may be applied to one or more output devices. An exemplary processing system includes any system having a processor, such as a microcontroller, digital signal processor (DSP), application specific integrated circuit (ASIC) or microprocessor. The programs may be implemented in a high-level procedural or object-oriented programming language for communicating with a processing system. The programs may also be implemented in any computer language, including assembly or machine languages, if desired. The programs may be stored on a storage media or device, e.g., hard disk drive, floppy disk drive, read only memory (ROM), CD-ROM device, flash memory device, digital versatile disk (DVD), or other storage devices readable by a general or special purpose programmable processing system, for configuring and operating the processing system when the storage media or device is read by the processing system to perform the procedures described herein. Embodiments of the invention may also be implemented in a machine-readable storage medium configured for use with a processing system, where the storage medium so configured causes the processing system to operate in a specific and predefined manner to perform the functions described herein.

In the foregoing detailed description, various aspects of the invention have been described. For illustrative purposes, specific numbers, systems and configurations are set forth herein in order to provide a thorough understanding of the invention. It is nonetheless apparent to one skilled in the art that the invention may be practiced without the specific details of the specific numbers, systems and configurations set forth herein.

Although the above examples are primarily described with computer networks, the invention is also advantageously applicable to any kind of network utilizing any kind of terminal or subscriber devices. The scope of applicability of the invention advantageously includes mobile phone network systems, personal digital assistant (PDA) devices, handyphone systems, cellular mobile devices of any scale, and any other communications systems utilizing a network, be it wired or wireless, large or small, as long as it may be subject to computer virus attacks.

Although the invention has been described with reference to the preferred embodiments, it will be understood that the invention is not limited to the details described thereof. Although the system and method according to the invention are described herein utilizing LANs as examples of implementation, the scope of the invention is not limited to LANs. Substitutions and modifications have been suggested in the foregoing description, and other will occur to those of ordinary skill in the art. In particular, the process steps of the method according to the invention will include methods having substantially the same process steps as the method of the invention to achieve substantially the same result. Therefore, all such substitutions and modifications are intended to be within the scope of the invention as defined in the appended claims and their equivalents.

I claim:

1. An early warning virus detection method in a network system having a plurality of data files and device nodes, the method comprising the steps of:
(a1) detecting data traffic flow in all said device nodes;
(a2) determining a neighborhood of said device nodes in said network system having unpredicted traffic flow;
(a3) designating those of said device nodes having unpredicted traffic flow as abnormal device nodes and those of said device nodes having predicted traffic flow as normal device nodes;
(a4) deploying at least one network neighborhood monitor for detecting data traffic flow in said abnormal device nodes;
(a5) partially isolating a segment in said network system including said abnormal device nodes;
(a6) scanning those of said data files in said isolated segment;
(a7) transferring an antivirus cure into said isolated segment for pinpointing at least one infected file among said data files in said network system that is infected by at least one computer virus;
(a8) preventing all traffic flow into said isolated segment except said transferred antivirus cure;
(a9) reducing the size of said isolated segment by rejecting all normal device nodes in said isolated segment; and
(a10) removing said at least one infected file from said isolated segment using said antivirus cure.

2. The method of claim 1 further comprising the step of quarantining said at least one infected data file.

3. The method of claim 1 further comprising the step of detecting a volume of said data traffic flow in a unit time interval.

4. The method of claim 1 further comprising the step of designating said data traffic flow as abnormal if a volume of said unpredicted traffic flow is larger than a volume of said predicted traffic flow with a predetermined value for a predetermined time period.

5. The method of claim 1 further comprising the step of analyzing said data traffic flow by analyzing said data files according to predetermined formats.

6. The method of claim 1 further comprising the steps of: analyzing a format of said data traffic flow; and designating said traffic flow as abnormal if said format does not conform with predetermined formats.

7. The method of claim 1 further comprising the step of mapping predetermined patterns to said data traffic flow.

8. The method of claim 1 further comprising the step of de-isolating said isolated segment after said at least one infected file is removed from said isolated segment.

9. The method of claim 1 further comprising the step of writing virus information of said at least one computer virus into a computer virus database, said virus information comprising date, file name, original location, creation date, last modified date, and file attributes of said at least one computer virus.

10. The method of claim 9 further comprising the step of displaying said virus information.

11. A network system comprising:
a plurality of data files;
a management server connected to a plurality of device nodes wherein those of said device nodes having unpredicted traffic flow are designated as abnormal device nodes and those of said device nodes having predicted traffic flow are designated as normal device nodes;
a management information database (MIB) connected to said management server;
at least one network neighborhood monitor deployed in said network system for detecting data traffic flow in said abnormal device nodes wherein a segment in said network system including said abnormal device nodes is partially isolated; and
an antivirus cure transferred into said isolated segment for pinpointing at least one infected file among said data files in said network system that is infected by at least one computer virus wherein all traffic flow into said isolated segment are prevented except said transferred antivirus cure; and
wherein said at least one infected file is removed from said isolated segment using said antivirus cure.

12. The network system of claim 11 further comprising a virus database storing virus information of said at least one computer virus.

13. The network system of claim 11 further comprising a virus database storing virus information of said at least one computer virus, said virus information comprising date, file name, original location, creation date, last modified date, and file attributes of said at least one computer virus.

14. The network system of claim 13 further comprising a display displaying said virus information.

15. The network system of claim II further comprising a scanner for detecting data traffic flow in said device nodes, said scanner storing a plurality of virus patterns.

16. The network system of claim 11 further comprising a network switch for switching data traffic flow in said abnormal device nodes.

17. The network system of claim 11 further comprising a quarantine module quarantining said at least one infected data file.

18. The network system of claim 11 wherein said data traffic flow is designated as abnormal if a volume of said unpredicted traffic flow is larger than a volume of said predicted traffic flow with a predetermined value for a predetermined time period.

19. The network system of claim 11 further comprising mapping means for mapping predetermined patterns to said data traffic flow.

20. The network system of claim 11 wherein said isolated segment is de-isolated after said at least one infected file is removed from said isolated segment.

21. A network system comprising:
a plurality of data files;
a management server connected to a plurality of device nodes;
a scanner for detecting data traffic flow in said device nodes, said scanner storing a plurality of virus patterns, wherein those of said device nodes having unpredicted traffic flow are designated as abnormal device nodes and those of said device nodes having predicted traffic flow are designated as normal device nodes;
at least one network neighborhood monitor deployed in said network system for detecting data traffic flow in said abnormal device nodes wherein a segment in said network system including said abnormal device nodes is partially isolated;
an antivirus cure transferred into said isolated segment for pinpointing at least one infected file among said data files in said network system that is infected by at least one computer virus; and
a network switch for switching data traffic flow in said abnormal device nodes wherein said at least one infected file is removed from said isolated segment using said antivirus cure.

22. The network system of claim 21 wherein all traffic flow into said isolated segment are prevented except said transferred antivirus cure.

23. The network system of claim 21 further comprising a virus database storing virus information of said at least one computer virus.

24. The network system of claim 21 further comprising a virus database storing virus information of said at least one computer virus, said virus information comprising date, file name, original location, creation date, last modified date, and file attributes of said at least one computer virus.

25. The network system of claim 24 further comprising a display displaying said virus information.

26. The network system of claim 21 further comprising a quarantine module quarantining said at least one infected data file.

27. The network system of claim 21 wherein said data traffic flow is designated as abnormal if a volume of said unpredicted traffic flow is larger than a volume of said predicted traffic flow with a predetermined value for a predetermined time period.

28. The network system of claim 21 further comprising mapping means for mapping predetermined patterns to said data traffic flow.

29. The network system of claim 21 wherein said isolated segment is de-isolated after said at least one infected file is removed from said isolated segment.

30. The network system of claim 21 wherein said network system comprises a local area network (LAN), mobile network, wired and wireless communications network.
